(19) United States
(12) Patent Application Publication
(10) Pub. No.: US 2019/0180244 A1
(43) Pub. Date: Jun. 13, 2019

(54) System and Method for Applying Artificial Intelligence and Highly Distributed Storage Systems to Human Resources Information Management

(71) Applicant: Romella Janene El Kharzazi, Springfield, VA (US)

(72) Inventor: Romella Janene El Kharzazi, Springfield, VA (US)

(21) Appl. No.: 15/836,864

(22) Filed: Dec. 9, 2017

(51) Int. Cl. G06Q 10/10; G06N 3/04; G06N 3/08

(52) U.S. Cl. CPC G06Q 10/105; G06N 3/04; G06N 3/08; G06N 3/0454; G06N 3/0445

(57) ABSTRACT

A system and/or a method based on converging blockchain and next-generation artificial intelligence for the administration of Human Resources activities and the subsequent recordkeeping and legal compliance responsibilities for designing a product/service, optimizing relevant processes and enhancing real-time and/or near real-time collaboration between many users is disclosed. Utilizing a secure and transparent distributed personal data marketplace utilizing highly distributed storage systems and deep learning technologies to resolve the challenges faced by auditors and regulators, while returning the control over personnel data, including hiring, payroll, benefits, retirement records back to the individuals, while safeguarding employee privacy, data integrity, and system security.

### REFERENCES CITED

### U.S. Patent Documents

| Application Number | Filing Date | Patent Number |
|---|---|---|
| 15/731,302 | May 22, 2017 | |
| 14/544,314 | Dec. 22, 2014 | 9,704,119 |
| 15/731,302 | | |
| 13/815,843 | Mar. 15, 2013 | 9,646,279 |
| 14/544,314 | | |
| 13/573,634 | Sep. 28, 2012 | 8,990,308 |
| 13/815,843 | | |
| 61/848,015 | Dec. 19, 2012 | |

### Other References

Polina Mamoshina, Lucy Ojomoko, Yury Yanovich, Alex Ostrovski, Alex Botezatu, Pavel Prikhodko, Eugene Izumchenko, Alexander Aliper, Konstantin Romantsov, Alexander Zhebrak, Iraneus Obioma Ogu, and Alex Zhavoronkov. Converging blockchain and next-generation artificial intelligence technologies to decentralize and accelerate biomedical research and healthcare. Oncotarget, pp. 1-26, 2017.https://doi.org/10.18632/oncotarget.22345

### BACKGROUND

Current Human Resources Information Systems (HRIS) still rely on many manual inputs into these systems and for utilizing the data they store. This is especially true with respect to analytics and the subsequent decision-making processes. Furthermore, from a records management perspective, there are many opportunities to have incorrect information input into the system without a clear record of who, why, and what was the activities the person who entered that information was attempting to complete. This presents major challenges to the integrity of the data captured and maintained in HRIS and accountability. While manual entry of information would still be possible, the automation of data through AI will greatly reduce manual entry and the types of entries necessary. Furthermore, the HDSS will create an irrefutable log of all HR activities, creating a data and transaction audit trail and complete user accountability.

The inspiration for this method or system came from my experience with implementing HRIS technology and from my involvement in internet governance. Furthermore, my prior HR work experience, including being involved in reengineering processes, provided the inspiration this invention. Finally, having worked as an expert in employment procedures for a Civil Rights enforcement agency, gave me insights into the challenges facing auditors of HR activities.

This proposed method or system creates a “device” that is a novel application of artificial intelligence and highly distributed storage systems (HDSS, for example, blockchain) that simplifies the administration of Human Resources activities and the subsequent recordkeeping and legal compliance responsibilities. This device optimizes relevant processes and enhancing real-time and/or near real-time collaboration between many users and utilizes a secure and transparent distributed personal data marketplace utilizing HDSS and deep learning technologies. This device also resolves the challenges faced by auditors and regulators, while returning the control over personnel data, including hiring, payroll, benefits, retirement records back to the individuals, while safeguarding employee privacy, data integrity, and system security.

### BRIEF DESCRIPTION OF THE DRAWINGS

The present disclosure is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one.

### LIST OF FIGURES

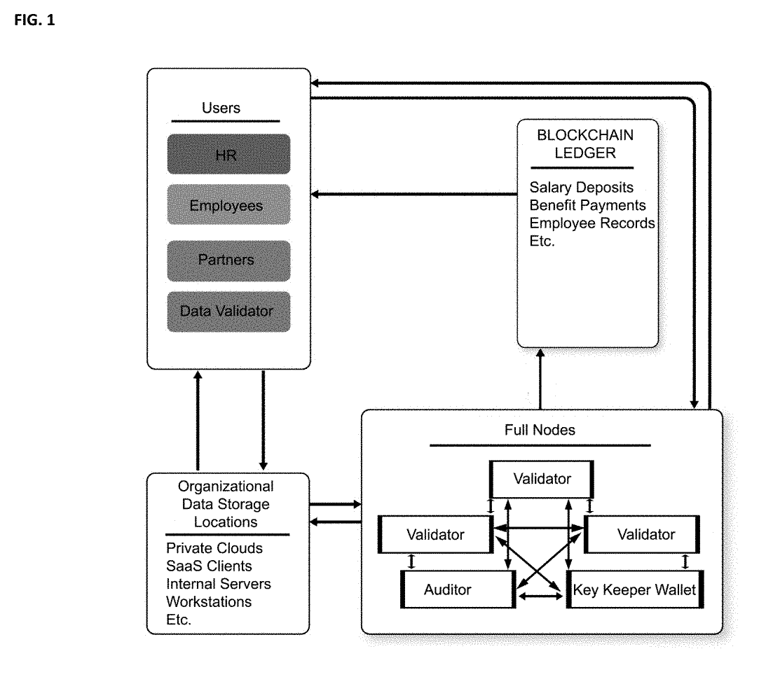

FIG. 1 is an example configuration which depicts the complete device/method/system described herein.

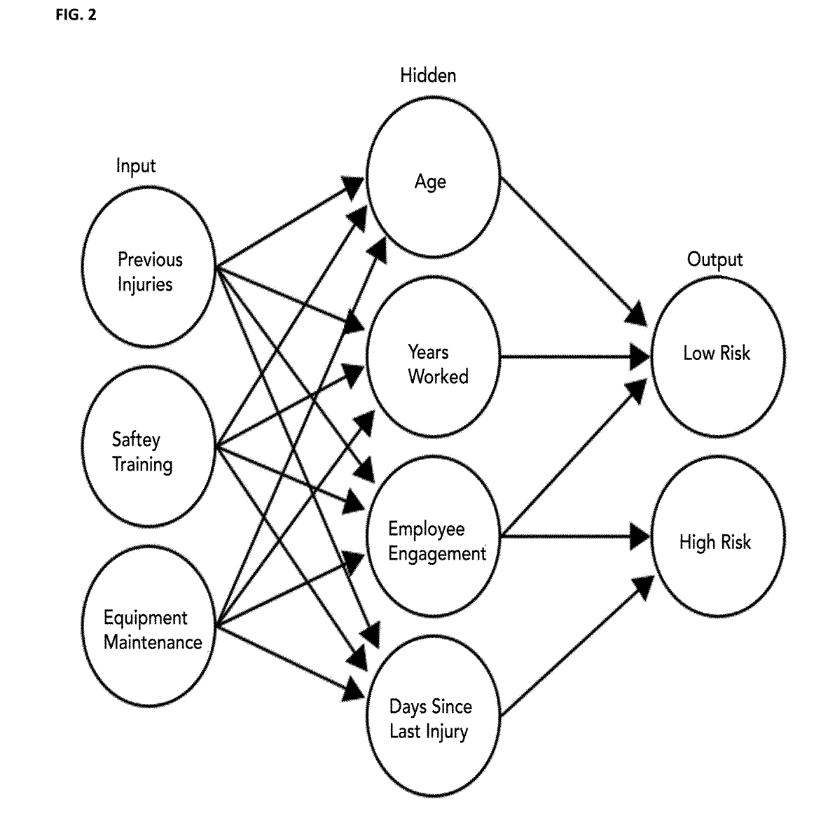

FIG. 2 is a Deep Neural Network (DNN) example which diagrams the prediction of the likelihood of workplace injuries.

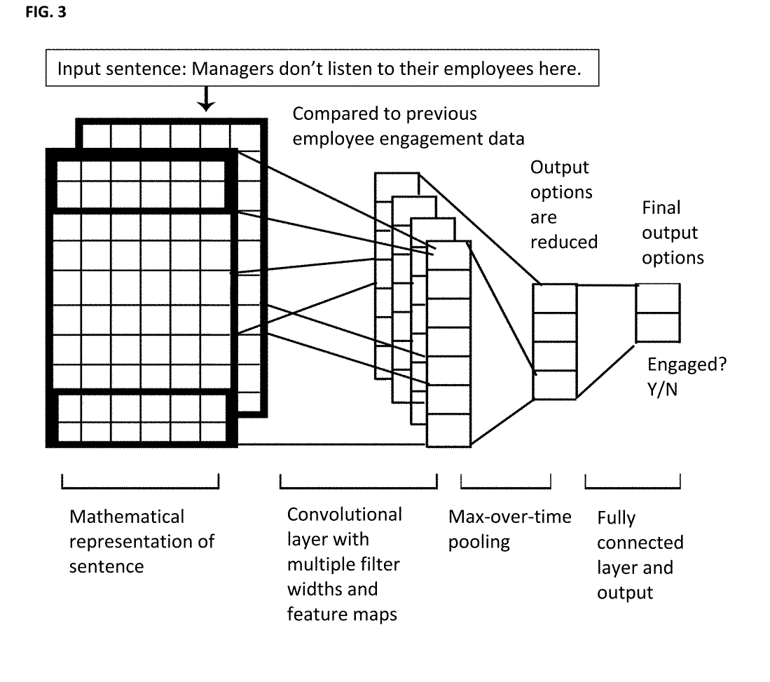

FIG. 3 is a Convolutional Neural Network (CNN) example of employee engagement feedback/comments correctly classifying the employee as being engaged or disengaged.

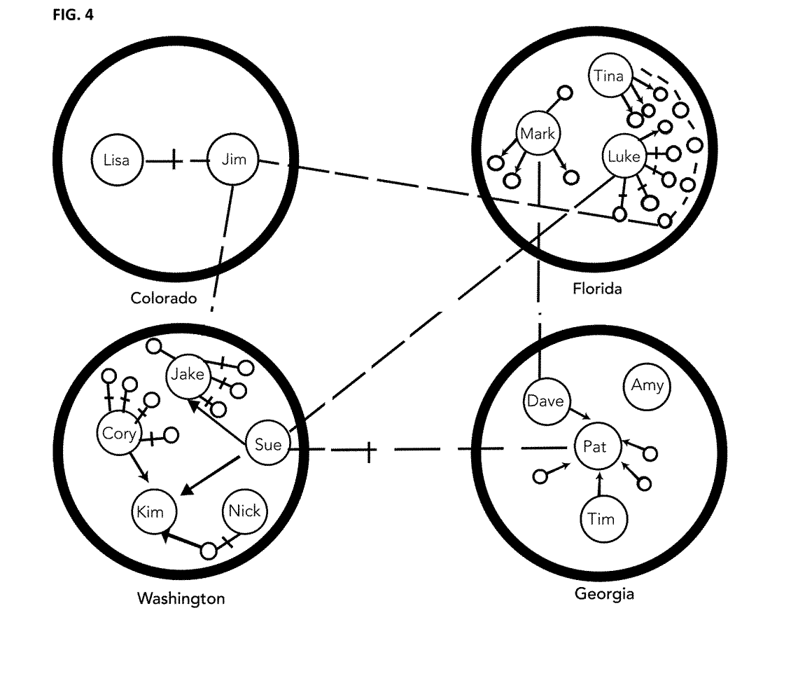

FIG. 4 is a Network Analysis (NA) example which depicts a map of influential employees by location and the relationship among employees between locations.

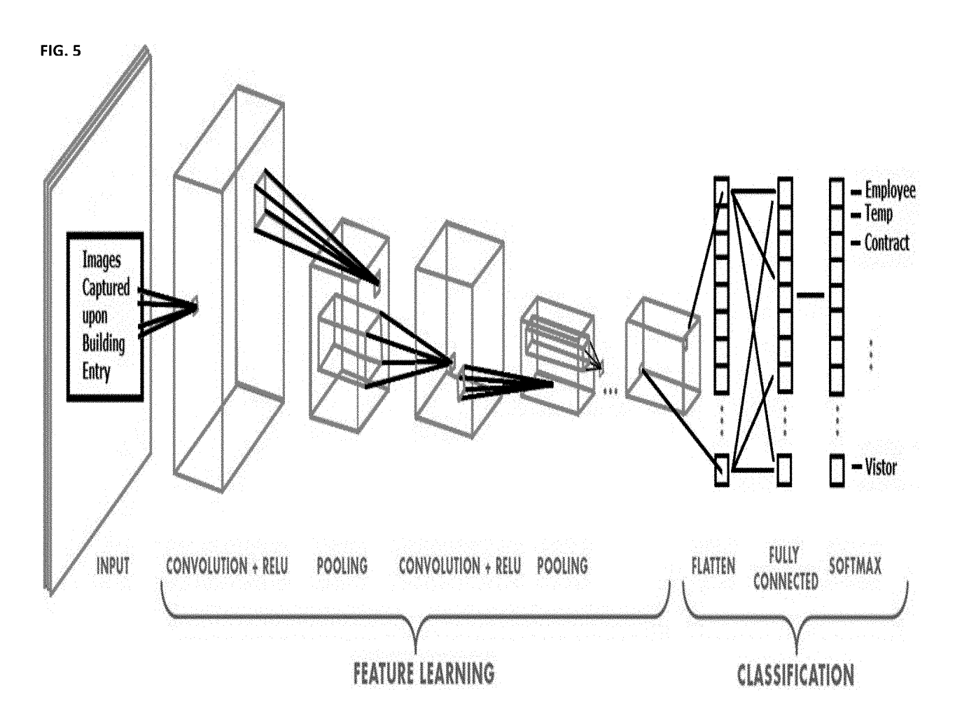

FIG. 5 is a Capsule Network (CN) example which depicts images of people being captured as they enter the building of an employer and the employer uses those images to correctly identify and classify those persons which are associated with the employer or as those who are unknown visitors to the building.

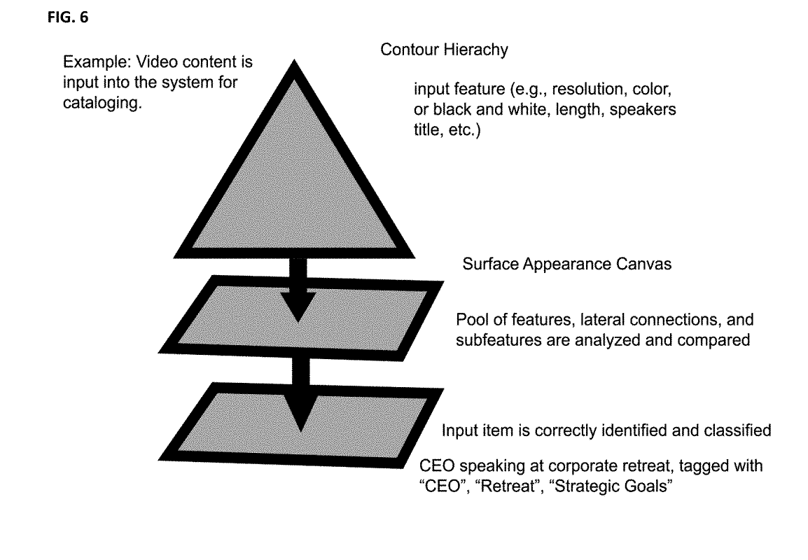

FIG. 6 is a Recursive Cortical Network (RCN) example of video content being correctly identified, cataloged, classified, and tagged a searchable reference by members of the organization.

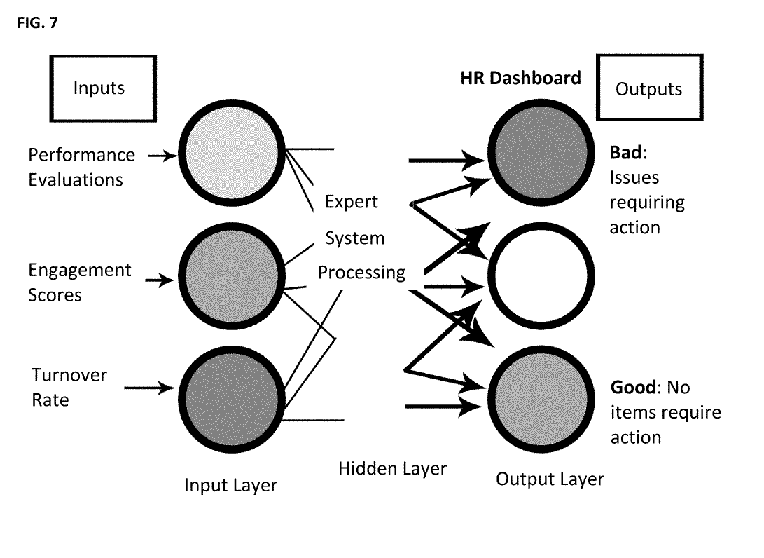

FIG. 7 is a Symbolic Learning (SL) example of a workforce dashboard, where human resources data is entered into the AI engine (i.e., algorithmic equation or equations) and a visual report card is returned.

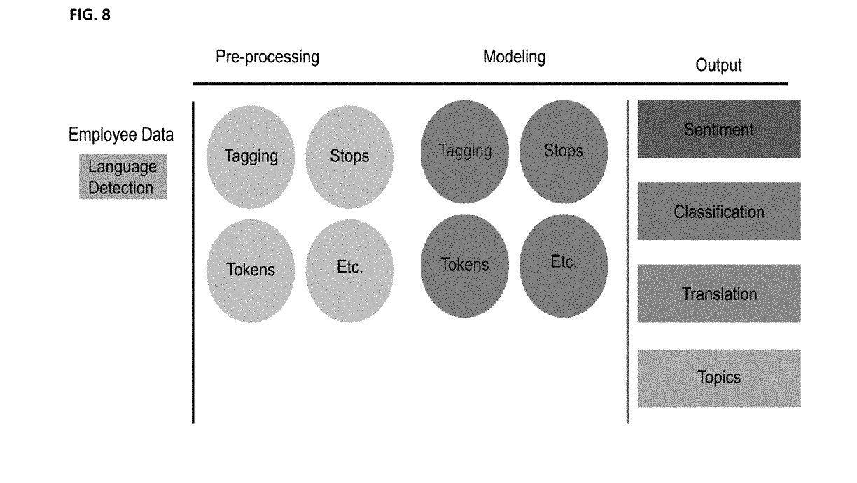

FIG. 8 is a Natural Language Processing (NPL) example of employee data from organizational operations around the world being processed, first for language, and then processed and modeled to determine the topics, classifications, and meaning with the ability to translate that information into different languages.

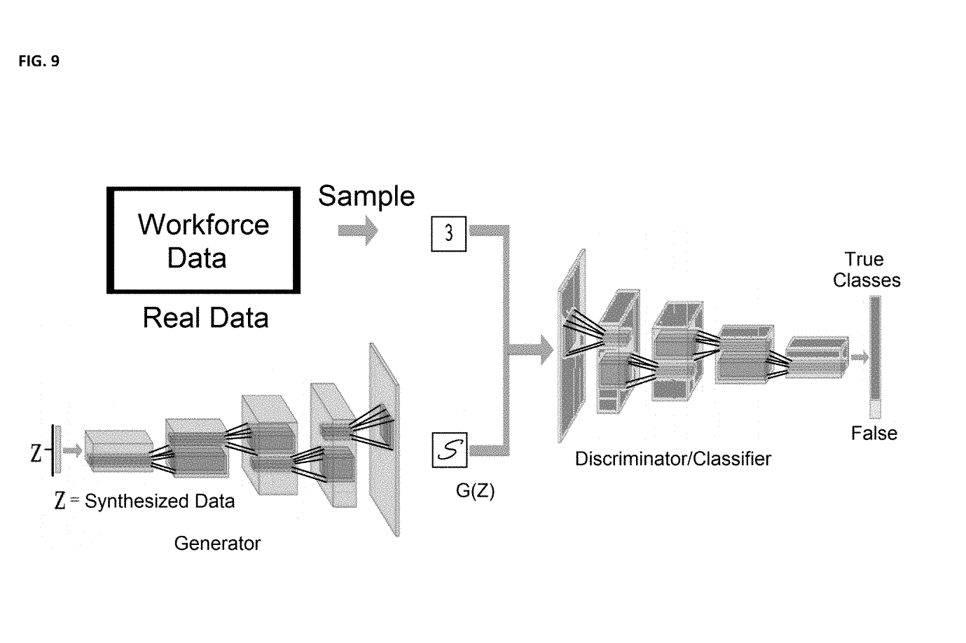

FIG. 9 is a Generative Adversarial Network (GAN) example of workforce data being fed into an AI engine while synthesized (i.e., simulated or random, etc.) data is simultaneously run to help improve the accuracy of the AI engine's ability to identify “fake” or “false positives” in workforce data and to correctly classify the real workforce data into meaningful categories.

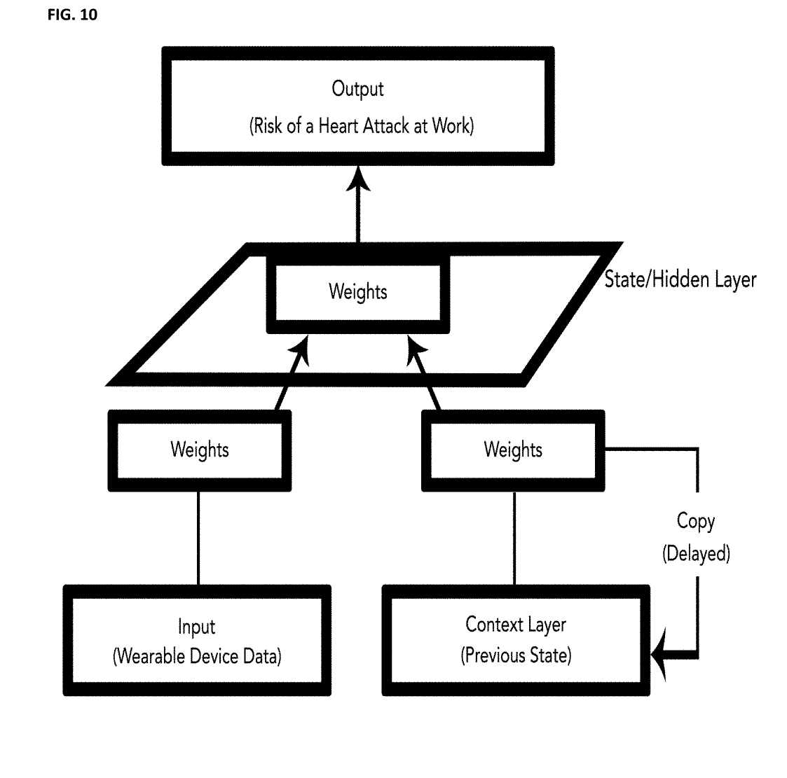

FIG. 10 is a Recurrent Neural Network (RNN) example of IoT wearable data being input into an AI engine that then calculates the likelihood of an employee having a heart attack at work.

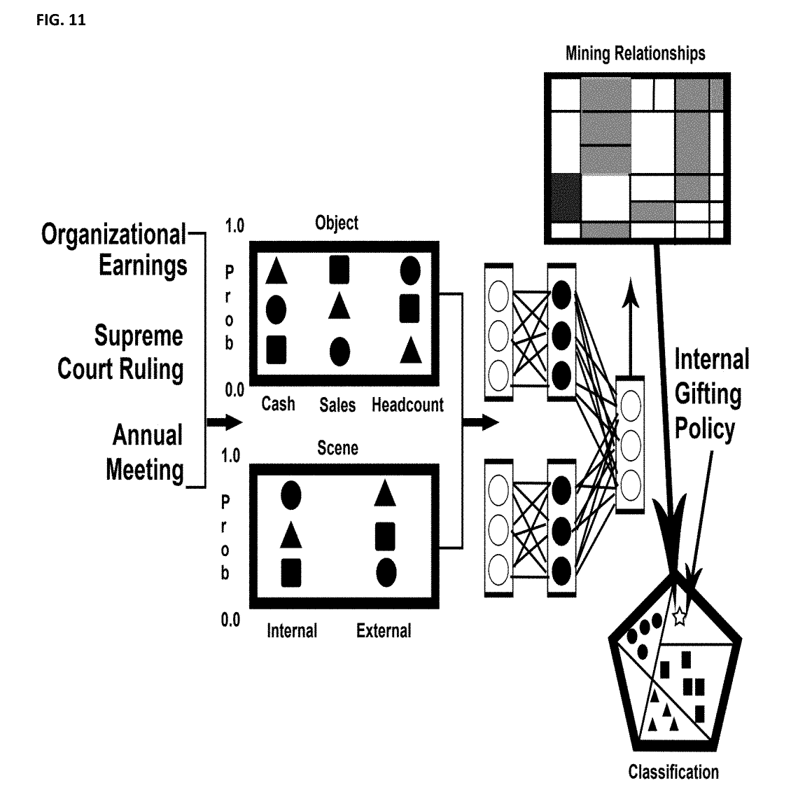

FIG. 11 is a Zero-Shot Learning Transfer Technique example that depicts data of diverse types from different contexts being processed in an AI engine that is mined for relationships to identify an event or issue that would not otherwise be obvious a possible outcome or even conceivable.

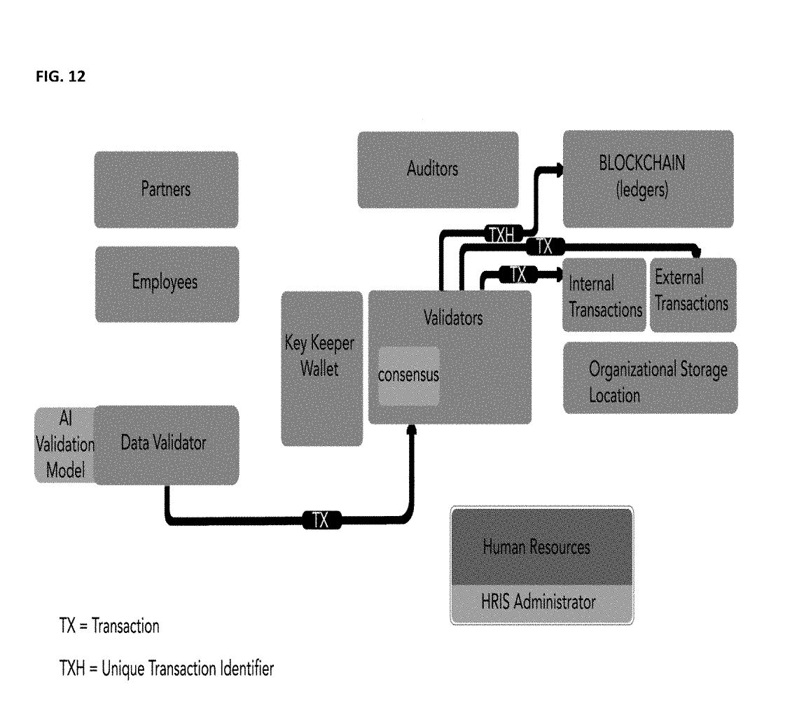

FIG. 12 is an HDSS example diagram that depicts one possible blockchain configuration and relationship map of the HRIS method described herein.

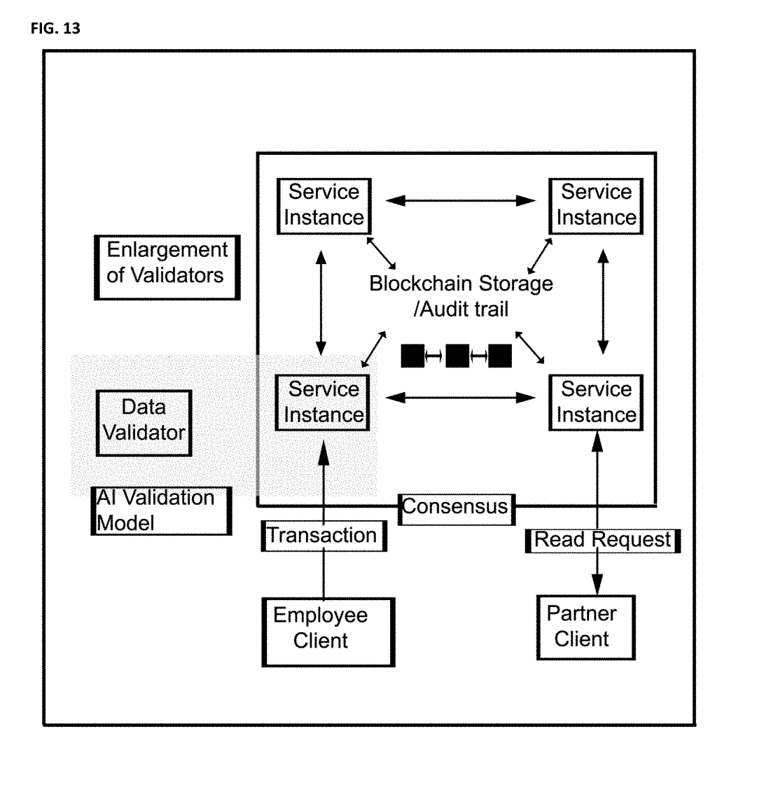

FIG. 13 is an HRIS example diagram that depicts one possible configuration of the HDSS and AI integration method/system described herein.

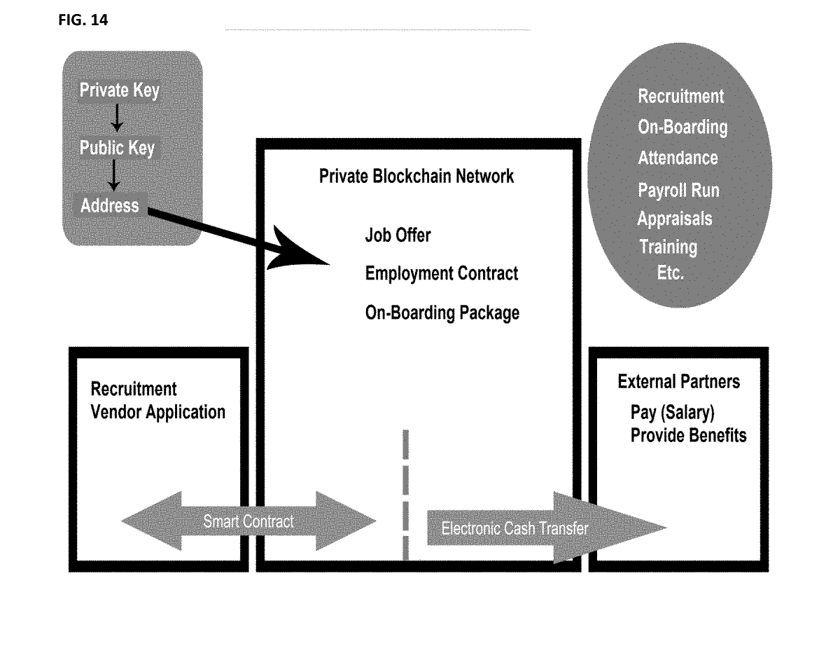

FIG. 14 is an example diagram of an organization's use of a blended/hybrid HDSS (e.g., blockchain) to manage vendor contracts/relationships, while safeguarding the integrity and privacy of its employees' data.

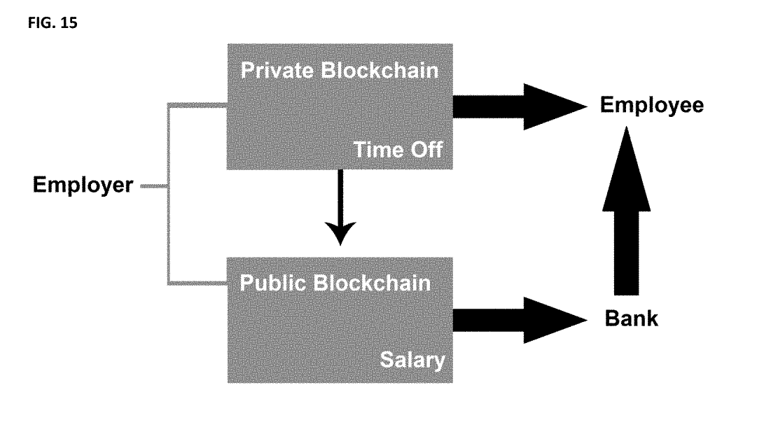

FIG. 15 is an example of an organization with both private and public blockchains that are anchored to existing external value markers (i.e., items of value; for example, money) or to internal, organizational-specific value markers (e.g., leave accrual).

Some aspects of these figures may be better understood by reference to the following Detailed Description.

### DETAILED DESCRIPTION

1. The proposed system or method is a novel application of advanced artificial intelligence (AI) to information management processes for Human Resources Management. The information includes both structured and unstructured data (i.e., numbers, figures, photographs, images, documents, email, system logs, etc.). (See FIG. 1)
   a. Deep Neural Networks (DNNs) will capture high-level dependencies in Human Resources data and will used be to predict various personnel events, such as tenure, turnover cause, injury, or likelihood of being disciplined. (See FIG. 2)
   b. Convolutional Neural Networks (CNNs) will be trained to classify employees on the likelihood of various personnel outcomes, such as performance, promotability, injury, or turnover. (See FIG. 3)
   c. Network Analysis (NA) will allow for the reduction of a number of input elements and preserving the process relevance at the same time, which is crucial for the auditing of the algorithms used for demonstrating legal compliance. Network analysis will also allow for the examination of organization culture, as well as the impact of the organization of the markets (product and geographical) in which it operates. (See FIG. 4)
   d. Capsule Networks (CN) will allow for the automatic processing of data image classification and address image classification problems of employee and organizational visual data. (See FIG. 5)
   e. Recursive Cortical Networks (RCNs) will act as a perception system to catalog and interpret the contents of employee and organizational photographs, videos, and other similar content (e.g., audio recording of employee meetings) by inferring patterns, where objects will be modeled as a combination of contours and surfaces. (See FIG. 6)
   f. Symbolic Learning (SL) will develop expert system processes using production rules to make deductions and to determine what additional information needed to complete transactions and other tasks and render that data in a dashboard (e.g., an HR transaction that has significant issues and requires more information would have a “red” ball placed before it in the ledger as an indication to take further action) or another symbolic representation. (See FIG. 7)
   g. Natural Language Processing (NPL) will be used to allow system users to query the HR data in the HRIS in the form of a question that they might pose to another person and the HRIS will interpret the essential elements of the human, language sentence. (See FIG. 8)
   h. Generative Adversarial Networks (GANs) will use customizable and scalable datasets to train an adversarial Autoencoder (AAE), which combines the properties of both the discriminator and the generator to detect trends in Human Resource data for workforce planning, crisis management, and other personnel events with critical organizational outcomes. (See FIG. 9)
   i. Recurrent Neural Networks (RNNs), including DeepConvLSTM, will be used for sequence analysis for text and/or time-series analysis of Human Resources processes and files, including individual employee personnel records. RNNs will also be used to analyze and predict human activity in an employment or work setting based on data from wearable devices. (See FIG. 10)
   j. Learning Transfer Techniques (e.g., One- and Zero-Shot) deal with restricted datasets with one-shot learning being used to recognize new data points based on only a few examples in the existing data and Zero-Shot Learning being used to detect new objects/data without seeing examples of those instances in the existing Human Resources data. It could be used to reveal undocumented norms, organizational customs, undetected issues, or forecast potential crises. (See FIG. 11)
2. The proposed system is a novel application of highly distributed storage systems (HDSS; for example, blockchain) to information management processes for human resources management. The information includes both structured and unstructured data (i.e., numbers, figures, photographs, images, documents, email, system logs, etc.).
   a. The data storage system will be highly reliable, secure, auditable, and scalable. Previous technologies and techniques have been employed to store data since the development of computer systems, however, with the exponential increase in data demands and computing power, HDSS presents a novel solution to the collection, storage, retrieval, reporting, and auditing of Human Resources data. The HDSS involves storing data in multiple nodes, which would be scaled as databases, host computers, cloud servers, etc. Data stored in these nodes will be replicated or redundant with HDSS providing quick access to data over the largest number of nodes possible. This HDSS system will be scaled either as a distributed database where users store information on a number of nodes, or as a computer network in which users store information on a number of peer network nodes. (See FIG. 12)
   b. The system will also enable RNNs, GANs, learning-transfer techniques, and the other types of the aforementioned AI to “collect” data that can then be added to the HDSS or node in personnel data systems for information management. (See FIG. 13)
   c. The HDSS is scalable as a private, public, or blended information management system. (See FIG. 14)
   d. The HDSS can be anchored to existing currencies (e.g., Bitcoin, U.S. Dollars, etc.) or to new or organizational specific value-markers (e.g, vacation days, company coupons, new cryptocurrencies, etc.), both tangible and electronic, may be created specifically for the HDSS and be indexed to existing currencies. (See FIG. 15)

### SCOPE AND SPIRIT OF THE PRESENT INVENTION

The foregoing description, for purpose of explanation, has been described with reference to specific embodiments. However, the illustrative discussions above are not intended to be exhaustive or to limit the scope of the disclosure to the precise forms disclosed. Many modifications and variations are possible in view of the above method or system and one AI method could be used to perform a different HRIS activity than for which it has been described or to fulfill a different need (e.g., RNNs used for images, instead of texts). The embodiments were chosen and described to best explain the principles of the disclosure and its practical applications, to thereby enable others skilled in the art to utilize the disclosure and various embodiments with various modifications as may be suited to the particular use contemplated. The patents or patent applications referenced herein were listed in order to provide information to the examiner about works that might be incorrectly viewed as prior art; however, these referenced patent documents do not describe a similar method or system for combining and applying AI and HDSS technology, as described herein, to the management of human resources information and data.

The scope and spirit of this invention shall be defined by the claims and the equivalents of the claims only. The exclusive use of all variations and/or modifications within the scope of the claims is reserved. Unless a claim term is specifically defined in the preferred “best mode” embodiments, then a claim term has ordinary meaning, as understood by a person with an ordinary skill in the art, at the time of the present invention. “Specifications teach. Claims claim.” (See Rexnord Corp. v. Laitram Corp., 274 F.3d 1336, 1344, Fed. Cir. 2001). The rights of claims (and rights of the equivalents of the claims under the Doctrine of Equivalents, meeting the Triple Identity Test: (a) performing substantially the same function; (b) in substantially the same way; and (c) yielding substantially the same result. (See Crown Packaging Tech., Inc. v. Rexam Beverage Can Co., 559 F.3d 1308, 1312, Fed. Cir. 2009). Claims of the present invention are not narrowed or limited by the selective import of the specifications (of the preferred embodiments of the present invention) into the claims. The term “means” was not used nor intended nor implied in the disclosed preferred best mode embodiments of the present invention. Thus, the inventor has not limited the scope of the claims as mean plus function. Furthermore, the scope and spirit of the present invention shall be defined by the claims and the equivalents of the claims only. The present invention is set forth in the aforementioned claims.

1. The proposed system or method is a novel application of advanced artificial intelligence (AI) and highly distributed storage systems (HDSS; for example, blockchain) to Information Management processes for Human Resources Management. The information includes both structured and unstructured data (i.e., numbers, figures, photographs, images, documents, email, system logs, etc.).

2. The AI HDSS can be anchored to existing currencies (e.g., Bitcoin, U.S. Dollars, etc.) or to new value-markers (e.g, vacation days, company coupons, new cryptocurrencies, etc.), both tangible and electronic, which may be created specifically for the HDSS and be indexed to existing currencies.
